(19) United States
(12) Patent Application Publication
(10) Pub. No.: US 2008/0134229 A1
(43) Pub. Date: Jun. 5, 2008

(54) METHODS AND APPARATUS FOR AWARDING CONSUMERS OF ADVERTISING CONTENT

(76) Inventor: Carson V. Conant, Glenview, IL (US)

Correspondence Address: BELL, BOYD & LLOYD, LLP, P.O. Box 1135, CHICAGO, IL, 60690, US

(21) Appl. No.: 11/565,302

(22) Filed: Nov. 30, 2006

(51) Int. Cl. H04N 7/173

(52) U.S. Cl. 725/23

(57) ABSTRACT

The present disclosure provides methods and apparatus for awarding consumers of advertising content. In general, a user of the disclosed system consumes a program (e.g., a television show) distributed from a program distributor (e.g., a television broadcaster) to a program player (e.g., a television). The program from the program distributor preferably includes entertainment content (e.g., a movie or sitcom) and a plurality of advertising elements (e.g., product placement advertisements). After consuming the content, the users may access an award server (e.g., via the Internet) to attempt to identify the advertising elements (e.g., by identifying the brand of soda a particular character was drinking). If a user correctly identifies a predetermined number of advertising elements (e.g., a certain percentage of products shown during a certain show), the award server facilitates a distribution of an award (e.g., a gift certificate) to the user.

### TECHNICAL FIELD

The present application relates in general to advertising and more specifically to methods and apparatus for awarding consumers of advertising content.

### BACKGROUND

Advertisers are becoming less interested in television because of the introduction of DVRs (Digital Video Recorders), such as Tivo®, which allow viewers to fast forward through commercials. In addition, with hundreds of channels now available through cable and satellite networks, users have many options to change channels during commercials. Consequently, advertisers are investing more in mediums where they know their advertisements are more effective. This is disruptive to television networks as they are facing the prospect of losing revenues. The television industry has sought several options to curtail this loss.

One method is for hardware manufacturers to restrict the ability to fast-forward or change channels during commercials, thereby forcing viewers to watch the commercials. However, this is meeting with significant public criticism and may push users to turn to pirated content on the Internet which does not have this limitation, or it may further push viewers toward user-created videos available online, a trend that is already occurring among younger audiences.

Another method is for advertisers to pay for their product or service to be used or placed within the content. This could be as subtle as the car a character drives or it could be more obvious such as a character asking specifically for a “Pepsi.” The problem with this type of advertisement is that if it is too obvious, viewers will react negatively to it. In addition, advertisers often will not pay as much for these placement advertisements because they are subtle and do not have the full attention of the user.

### SUMMARY

The present disclosure provides methods and apparatus for awarding consumers of advertising content. In general, a user of the disclosed system consumes a program (e.g., a television show) distributed from a program distributor (e.g., a television broadcaster) to a program player (e.g., a television). The program from the program distributor preferably includes entertainment content (e.g., a movie or sitcom) and a plurality of advertising elements (e.g., product placement advertisements or traditional advertising spots). After consuming the content, the users may access an award server (e.g., via the Internet) to attempt to identify the advertising elements (e.g., by identifying the brand of soda a particular character was drinking). If a user correctly identifies a predetermined number of advertising elements (e.g., a certain percentage of products shown during a certain show), the award server facilitates a distribution of an award (e.g., a gift certificate) to the user.

### BRIEF DESCRIPTION OF THE FIGURES

FIG. 1 is a high level block diagram of an example communications system.

FIG. 2 is a more detailed block diagram showing one example of a computing device.

FIG. 3 is a flowchart showing one example of a system for awarding consumers of advertising content.

FIG. 4 is block diagram of an example audiovisual experience for a user.

FIG. 5 is block diagram of an example process for user interaction with an Internet service.

FIG. 6 is block diagram of an example audio experience for a user.

FIG. 7 is block diagram of an example where a user attempts identify a plurality of advertising elements from a plurality of different audiovisual programs.

FIG. 8 is block diagram of an example where a user must accurately identify all of the advertising elements associated with a program in a correct chronological order to win an award.

FIG. 9 is block diagram of an example where a user must accurately identify a subset of advertising elements associated with a program in any chronological order to win an award.

FIG. 10 is block diagram of an example where a user must accurately identify a plurality of advertising elements associated with a program by entering or selecting details about those advertising elements.

FIG. 11 is an example screenshot showing a selection list used to enter attempts associated with advertising elements.

FIG. 12 is an example screenshot showing another entry method wherein an interface requests additional details about an advertising element.

### DETAILED DESCRIPTION

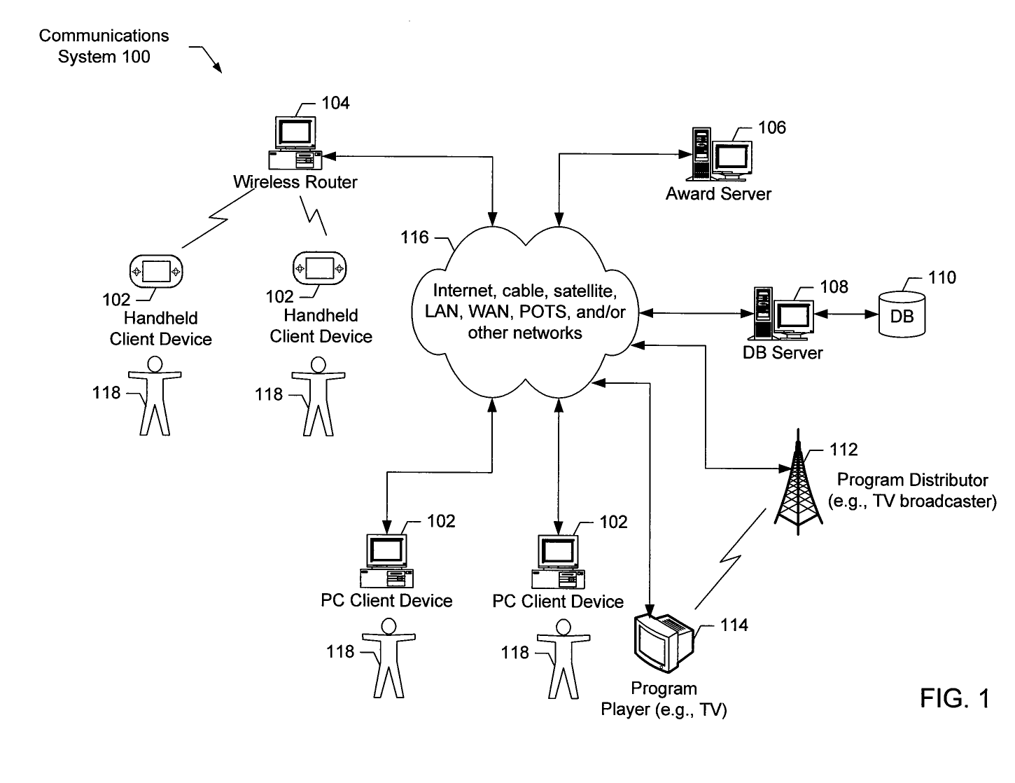

The present system is most readily realized in a network communications system. A high level block diagram of an exemplary network communications system 100 is illustrated in FIG. 1. The illustrated system 100 includes one or more client devices 102, one or more wireless routers 104, one or more award servers 106, one or more database servers 108 connected to one or more databases 110, one or more program distributors 112, and one or more program players 114. Each of these devices may communicate with each other via a connection to one or more communications channels 116. The communications channels 116 may be any suitable communications channels 116 such as the Internet, cable, satellite, local area network, wide area networks, telephone networks, etc. It will be appreciated that any of the devices described herein may be directly connected to each other and/or connected over one or more networks.

In an example mode of operation, users 118 of the system 100 consume one or more programs distributed from a program distributor 112 to a program player 114. The program may be any suitable type of program such as a movie, a situation comedy, a documentary, etc. The program distributor 112 may be any suitable program distributor 112, such as a terrestrial television broadcaster, a cable television broadcaster, a satellite television broadcaster, a terrestrial radio broadcaster, a satellite radio broadcaster, an Internet show provider, etc. Similarly, the program player 114 may be any suitable program player 114, such as a television, a satellite television receiver, a cable television receiver, an audiovisual playback device, a radio, a client device 102, etc. For example, a television broadcaster may broadcast audiovisual content to a plurality of televisions, and the television broadcaster may allow users 118 at client devices 102 to download the audiovisual content via the Internet.

Each program from the program distributor 112 preferably includes entertainment content and a plurality of advertising elements. For example, an audiovisual program, such as a movie or sitcom, may include one or more spot advertisements and/or one or more placement advertisements associated with one or more different advertisers. Spot advertisements interrupt a flow of the entertainment content. For example, a sports broadcast may be interrupted to show a Coca-Cola® commercial. Placement advertisements do not interrupt the flow of the entertainment content. For example, a character in a movie may drink a Coca-Cola®. Either type of advertising element may be for a product and/or a service.

After consuming the content, the users 118 may access the award server 106 to attempt to identify one or more of the advertising elements. Preferably, the users 118 access the award server 106 via the communications channels 116 using a client device 102. For example, the award server 106 may transmit a web page to a client device 102 via the Internet. The web page (or other software) may be associated with one or more audiovisual programs. For example, the web page may be associated with a particular show (e.g., Monday Night Football) and/or a group of shows such as some (e.g., the Thursday night line up) or all of the programs from a particular content company (e.g., NBC).

Preferably, the users 118 attempt to identify the advertising elements by identifying one or more aspects associated with the advertising elements. The aspects of the advertising elements may include information such as a product name, a product type, a service name, a service type, a brand name, an entity name, a product color, a product model, a product version, a product feature, a product action, etc. For example, the users 118 may need to identify a color associated with an advertised car. Preferably, the web page enables users 118 to identify the advertising element aspects by entering alphanumeric data, selecting items from a list of items, and/or using a search feature.

In response to an attempt to identify the advertising elements, the award server 106 preferably accesses one or more data structures to determine if the user correctly identifies the plurality of advertising elements Preferably, the data structure(s) store data indicative of a plurality of advertising element aspects in logical association with data indicative of one or more entertainment programs. For example, the award server 106 may access a database 110 to determine if a car advertised during a situation comedy (sitcom) was red in color. The database 110 may be local to the award server 106, and/or the award server 106 may access the database 110 via the communications channel(s) 116 and a database sever 108. For example, a data structure indicative of a plurality of advertising element aspects and one or more audiovisual programs associated with those advertising element aspects may be stored on a content company (e.g., NBC) server and accessed by the award server 106 via a web service.

If a user 118 correctly identifies a predetermined number of advertising elements (e.g., a certain percentage) in association with one or more programs, the award server 106 preferably facilitates a distribution of one or more awards to the user 118 for correctly identifying the advertising element(s). The award may be a monetary award, a product, a service, etc. For example, if a user correctly identifies at least one aspect of every advertising element shown during a particular show, the award server 106 may transmit a gift certificate code (e.g., an iTunes® code) to a client device 102 associated with the user 118 via the communications channel(s) 116, or the award server 106 may cause a product to be physically sent to the user 118 (e.g., an iPod® advertised in the particular show), or the award server 106 may cause a check or bank deposit to be distributed to the user 118.

The award server 106 may be programmed to require the user 118 to correctly identify some or all of the advertising elements associated with one or more programs in any suitable manner. For example, the award server 106 may require the advertising elements to be identified with a chronological order and/or within some predetermined time frame. The predetermined time frame may be defined in any suitable manner. For example, the predetermined time frame may be defined by a specific time on a specific date of a specific year, and/or the predetermined time frame may be a predetermined offset from a display time associated with the program.

Similarly, the award server 106 may associate various award levels with different user performances. For example, the award server 106 may determine accuracy scores (e.g., percent of advertising elements correctly identified) and/or timeliness scores (e.g., higher weight given to correctly identifying advertising elements soon after a show is released) and award better prizes to users 118 with better accuracy and/or timeliness scores. Accuracy and/or timeliness scores may be based on one attempt to identify advertising elements, an average of all attempts by a particular user, a running average of all attempts by a particular user, determined relative to other users, etc. For example, a predetermined best prize for a particular show or shows may be awarded to the most accurate user 118 to respond within twenty four hours of the show's release, regardless of the user's raw score.

Similarly, certain awards may be given to consistently high scoring users 118. For example, a running score, such as a user's average score over that user's last ten attempts, may be used to determine if a certain award is given to a user 118. Running scores may be based on any suitable function associated with any selection of attempts. For example, a running score may be the sum of a user's top ten scores. In addition, the award server 106 may be programmed to limit the number of winning users 118. For example, the award server 106 may limit the number of winners to the users 118 with the top ten accuracy and/or timeliness scores.

One award server 106 may interact with a large number of client devices 102. Accordingly, each award server 106 is typically a high end computing device with a large storage capacity, one or more fast microprocessors, and one or more high speed network connections. Conversely, relative to a typical award server 106, each client device 102 typically includes less storage capacity, less processing power, and a slower network connection.

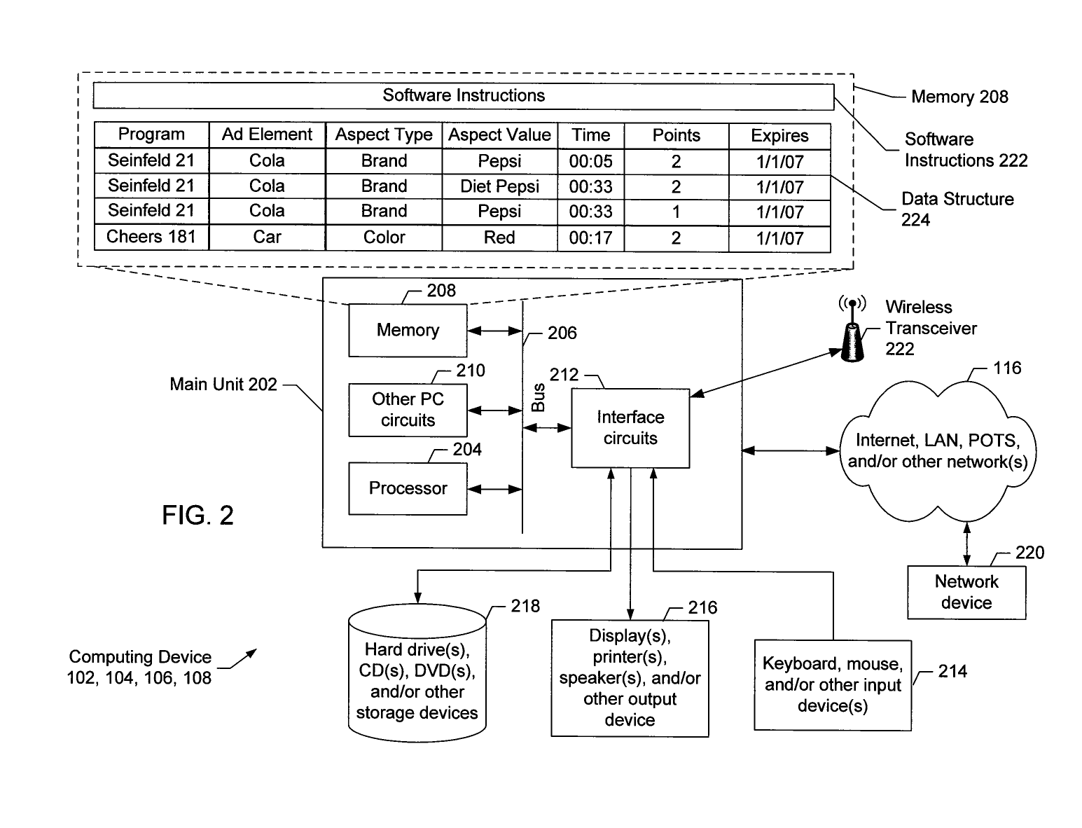

A detailed block diagram of an example computing device 102, 104, 106, 108, 114 is illustrated in FIG. 2. Each computing device 102, 104, 106, 108, 114 may include a server, a personal computer (PC), a personal digital assistant (PDA), a portable audio player, a portable audio/video player, a mobile telephone, a television remote control and/or any other suitable computing device. Each computing device 102, 104, 106, 108, 114 preferably includes a main unit 202 which preferably includes one or more processors 204 electrically coupled by an address/data bus 206 to one or more memory devices 208, other computer circuitry 210, and one or more interface circuits 212. The processor 204 may be any suitable microprocessor.

The memory 208 preferably includes volatile memory and non-volatile memory. Preferably, the memory 208 and/or another storage device 218 stores software instructions 222 that interact with the other devices in the system 100 as described herein. These software instructions 222 may be executed by the processor 204 in any suitable manner. The memory 208 and/or another storage device 218 may also store one or more data structures 224, digital data indicative of documents, files, programs, web pages, etc. retrieved from another computing device 102, 104, 106, 108, 114 and/or loaded via an input device 214.

The example data structure 224 show in FIG. 2 indicates that a program called “Seinfeld 21” included a “Cola” advertising element. One aspect of the “Cola” advertising element was the “Brand” of the “Cola” advertising element. In this example, the “Value” of the “Brand” of the “Cola” advertising element was “Pepsi” at “Time” “0:05”, “Diet Pepsi” at time “00:33”, and also “Pepsi” at time “00:33”. Optionally, the award server 116 may use the “Time” value to check if a user 118 identified the advertising elements in the correct chronological order. In this example, the data structure 224 indicates that a user 118 should be awarded two points for identifying a specific aspect (e.g., “Diet Pepsi”), but only one point for identifying a more general version of the same aspect (e.g., “Pepsi”). In addition, this example data structure 224 also includes a expiration time for each entry. Optionally, the award server 116 may use the “Expires” value to restrict user 118 attempting to identify advertising elements associated with an “old” program.

It will be appreciated that many other data fields and records may be stored in the data structure 224 to facilitate implementation of the methods and apparatus disclosed herein. In addition, it will be appreciated that any type of suitable data structure (e.g., a flat file data structure, a relational database, a tree data structure, etc.) may be used to facilitate implementation of the methods and apparatus disclosed herein.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), or any other type of display. The display 216 generates visual displays of data generated during operation of the computing device 102, 104, 106, 108, 114. For example, the display 216 may be used to display web pages received from the award server 106. The visual displays may include prompts for human input, run time statistics, calculated values, data, etc.

One or more storage devices 218 may also be connected to the main unit 202 via the interface circuit 212. For example, a hard drive, CD drive, DVD drive, flash memory drive, and/or other storage devices may be connected to the main unit 202. The storage devices 218 may store any type of data used by the computing device 102, 104, 106, 108, 114.

Each computing device 102, 104, 106, 108, 114 may also exchange data with other computing devices 102, 104, 106, 108, 114 and/or other network devices 220 via a connection to the communication channel(s)

116. The communication channel(s) 116 may be any type of network connection, such as an Ethernet connection, WiFi, WiMax, digital subscriber line (DSL), telephone line, coaxial cable, etc. Users of the system 100 may be required to register with the award server 106. In such an instance, each user may choose a user identifier (e.g., e-mail address) and a password which may be required for the activation of services. The user identifier and password may be passed across the communication channel(s) 116 using encryption built into the user's browser, software application, or device. Alternatively, the user identifier and/or password may be assigned by the award server 106.

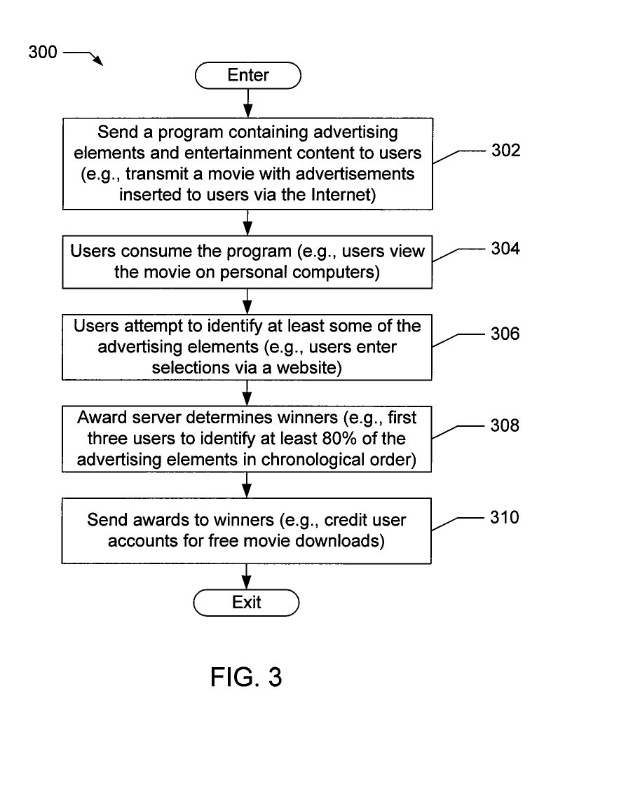

A flowchart of an example process 400 for awarding consumers of advertising content is presented in FIG. 3. Preferably, the process 300 is embodied in one or more software programs which is stored in one or more memories and executed by one or more processors. Although the process 300 is described with reference to the flowchart illustrated in FIG. 3, it will be appreciated that many other methods of performing the acts associated with process 300 may be used. For example, the order of many of the steps may be changed, and some of the steps described may be optional.

In this example, the process 300 sends a program containing advertising elements and entertainment content to users (block 302). For example, a program distributor 112 may transmit a movie with advertisements inserted to users via the Internet. Users 118 then consume the program using a program player 114 (block 304). For example, users may view the movie on a personal computer. After a user 118 consumes one or more programs, the user 118 may attempt to identify at least some of the advertising elements in those program(s) (block 306). For example, the user 118 may go to a website served by the award server 106 and enter a plurality of selections. The award server 106 then determines one or more winners (block 308). For example, the award server 106 may determine that the first three users to identify at least 80% of the advertising elements associated with a particular program in chronological order are winners. Once the award server 106 determines one or more winners, the award server 106 sends one or more awards to those winners (block 310). For example, the award server 106 may credit a user's accounts for one or more free movie downloads.

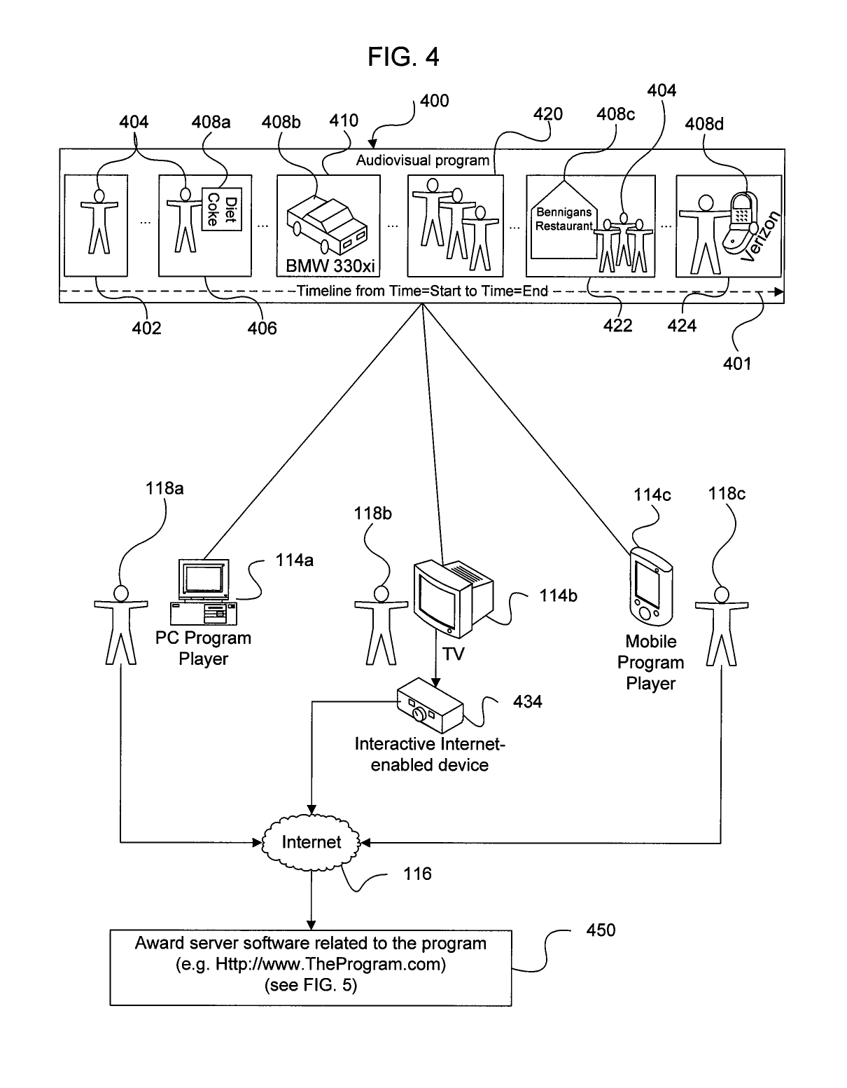

FIG. 4 illustrates an example audiovisual experience for a user 118. A program distributor 112 makes an audiovisual program 400 available to a plurality of users 118. Users 118a, 118b, 118c depict three audiovisual program viewers. In this example, the program distributor 112 sends the audiovisual program to several different audiovisual program players 114a, 114b, and 114c. More specifically, the example users 118a, 118b, 118c experience program 400 on a computer 114a, a television 114b, and a mobile device 114c respectively. A mobile device includes any suitable portable device used to experience a program such as a portable digital media player, iPod®, an mp3 player, a radio, a PDA (personal digital assistant), portable video player, a mobile phone, etc.

The example audiovisual program 400 is a contiguous audiovisual experience starting at time=start and ending at time=end depicted by example timeline 401 which contains a plurality of entertainment content and/or advertisement segments (or scenes). The program content may be any type of suitable program content including interactive content such as a video game. In this example, six segments within audiovisual program 400 are represented by boxes 402, 406, 410, 420, 422, and 424. Segments 402 and 420 represent content segments with various characters from the program. Segments 406, 422, and 424 represent product placement segments because the program's characters and/or props may be seen with, or interact with, one or more advertising elements. In segment 406, a character 404 is seen holding a product 408a (e.g., a can of Diet Coke). In segment 422, several characters 404 are seen walking into a restaurant 408c (e.g., Bennigans®). In the last scene 422, a character is shown using a Verizon® cellular telephone 408d which is an advertising element for Verizon® cellular phone service. Segment 410 represents a traditional spot advertisement in which the example audiovisual program 400 is interrupted for the spot advertisement segment 410, and the audiovisual program 400 resumes after one or more such spot advertisements. In this example, the spot advertisement is for a BMW's 330xi model car 408b. It will be readily appreciated that advertising elements could be for anything an advertiser wished to advertise, such as but not limited to products, services, companies, brands, initiatives, awareness, etc. Additionally, it will be readily appreciated that although only four advertising elements are shown in FIG. 4, there can be any number of advertising elements within the program, either as placements within the program content and/or as traditional spot advertisements which interrupt the program content.

After one or more of the users 118a, 118b, 118c watch the program 400, the users 118a, 118b, 118c may access an Internet service 450 which corresponds to the audiovisual program 400. As shown, the users 118a, 118b, 118c may access the Internet service 450 from any suitable client device 102 and/or program player 114. For example, user 118a accesses the Internet service 450 via the computer 114a he used to view the audiovisual program 400. Similarly, user 118c accesses the Internet service 450 via his mobile device 114c. User 118b views the program on his television 114b and then accesses the Internet service 450 through the same television 114b by way of an interactive Internet enabling device 434. Device 434 allows user 118b to interact with the Internet service 450 visually via the user's television 114b.

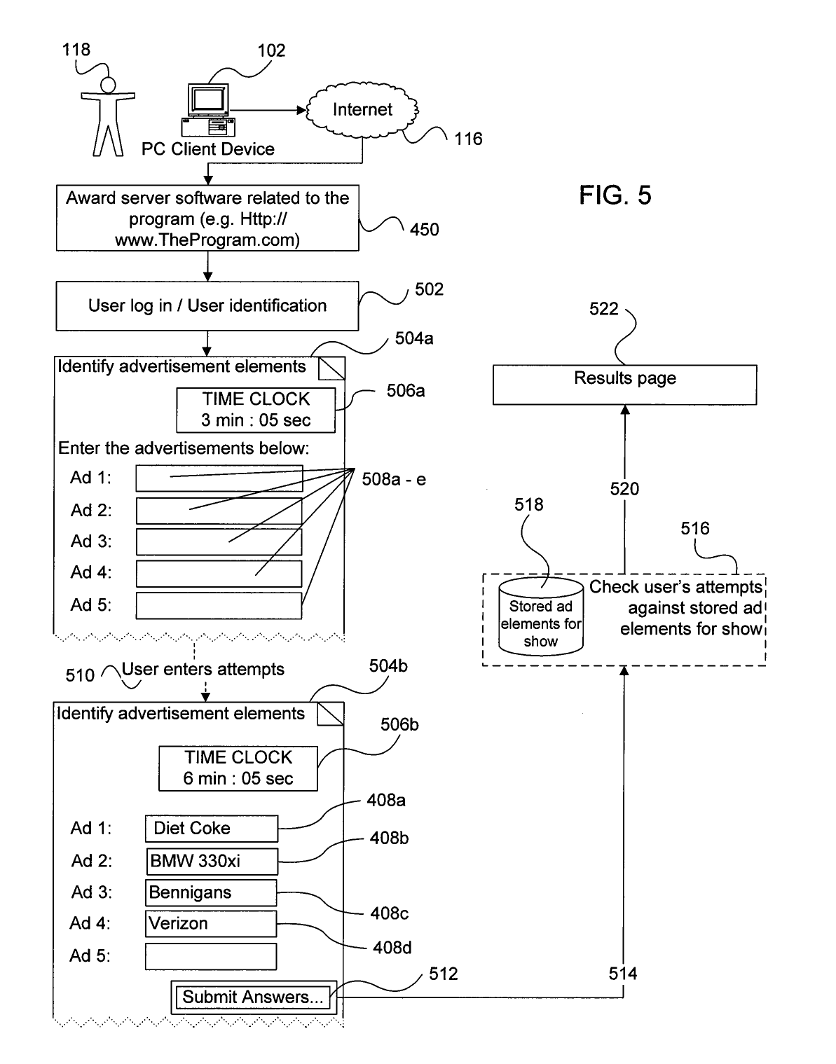

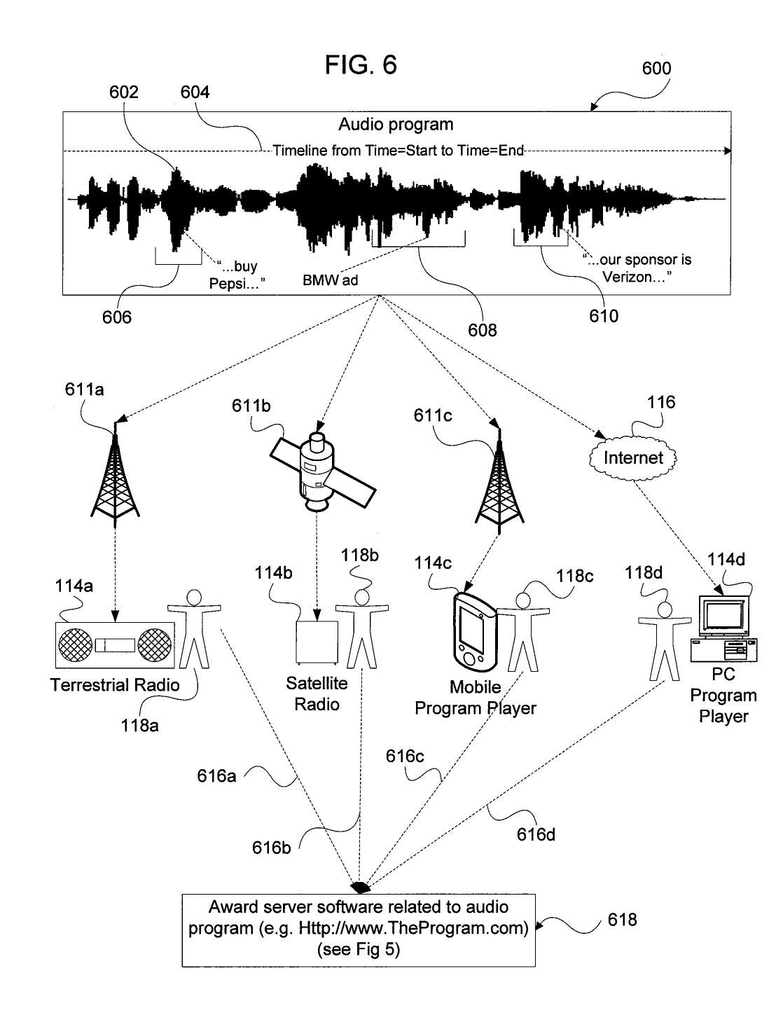

An example process for user interaction with an Internet service 450 is illustrated in FIG. 5. As discussed above with reference to FIG. 4, a plurality of users may access the Internet service 450 from a plurality of different devices 102, 114. In the illustrated example, Internet service 450 corresponds to audiovisual program 400. An example user 118 accesses the Internet service 450 via a client device 102 and a communications channel 116 such as the Internet. Although web page like displays are used in the examples herein, it will be readily appreciated that any suitable interactive displays may be used in conjunction with any suitable devices.

The user 118 then identifies himself via the login screen 502 so that responses from that user 118 can be associated with that user 118. After login, the user 118 views a page 504 (represented in two instances as 504a and 504b). In this example, the page 504a includes five text boxes 508a, 508b, 508c, 508d, 508e. Using these text boxes 508a, 508b, 508c, 508d, 508e, the user 118 can attempt to enter information associated with each of the advertising elements from the program 400. In this example, there is also a timer clock 506a which is counting the amount of time since the program has ended, which may correspond to the time the contest has been active.

The user 118 then enters information associated with the advertising elements into the text boxes 508a, 508b, 508c, 508d, 508e, depicted by the dotted action line 510. Page 504b depicts page 504a after the user has input four responses into the text boxes 508a, 508b, 508c, 508d, 508e. Preferably, the inputs correspond to attempts to identify the advertising elements from the audiovisual program 400, such that the first attempt, Diet Coke 408a, is entered into the first advertising element text box 508a. Similarly, attempts 408b, 408c, and 408d are entered into advertising element boxes 508b, 508c, and 508d respectively. In this example the user 118 has left text box 508e blank. It should be appreciated that advertising elements may be associated with broad concepts such as Bennigans restaurants or Verizon cell phone service, or advertising elements may be associated with a specific version of a product or service such as the Diet Coke brand of Coke or BMW's 330xi model car.

Once the user 118 has input one or more attempts at identifying the advertising elements, the user 118 may submit the attempts via a submit button 512. In this example, the clock timer 506b displays 6 minutes, 5 seconds at the time the user 118 submits his attempts. The user's attempts are then transferred via connector 514 to logic block 516 wherein the award server 106 compares the submitted attempts to the correct answers for the corresponding audiovisual program 400 to determine an accuracy score and/or a timeliness score associated with the submitted attempts. The user 118 is then shown a results page 522 illustrated by connector 520. The results page 522 displays what the user 118 has won (if anything) based on a series of factors, such as but not limited to the accuracy of his entries, the elapsed time 506b, the user's rank in order compared to other participants, etc.

FIG. 6 illustrates an example audio experience for a user 118. In this example, a program distributor 112 makes an audio program 600 available to a plurality of users 118. An audio program may include a terrestrial radio broadcast, a satellite radio broadcast, an online audio download, a podcast, online audio streaming, etc. The example audio waveform 602 represents audio signals within the audio program 600. In this example, the audio program 600 has a beginning and an end represented by a timeline 604. Furthermore, certain segments 606, 608, 610 of the audio program 600 are highlighted. These segments 606, 608, 610 pertain to advertising elements within the audio program 600 similar to the audiovisual advertising segments 406, 410, 422, and 424 of FIG. 4. In the case of an audio program 600, the audio advertising elements can be traditional spot advertisements, such as a BMW advertisement 608. In addition, advertising elements in the audio program 600 may be placement advertising elements such mentions of products and/or services within the audio program 600. These types of advertisements are represented by the highlighted segments 606 and 610. In the case of audio segment 606, the audio program mentions, “buy Pepsi.” This is an advertising element for Pepsi Cola. Similarly, the audio segment 610 mentions, “our sponsor is Verizon cellular phone service.” This is an advertising element for Verizon cell phone service.

There are many ways for users to access and experience audio programs. For example, users 118a, 118b, 118c, and 118d may listen to audio program 600 on a terrestrial radio 114a, a satellite radio 114b, a mobile device 114c, and a computer 114d respectively via a terrestrial radio network 611a, a satellite network 611b, a mobile broadband connection 611c, and an Internet connection 611d respectively. The mobile device 114c represents any suitable device for listening to an audio program, such as but not limited to a digital audio player, a PDA (Personal Digital Assistant), a mobile phone, and/or a portable computer.

Users 118a, 118b, 118c, 118d can then access an Internet service 618 associated with the audio program 600, as illustrated by dashed lines 616a, 616b, 616c, 616d whereby a user 118 can enter information associated with the advertising elements the user heard during the program 600. When a user 118 accesses the Internet service 618, the user 118 may be presented with a depiction and/or description of the award(s) the user 118 is trying to obtain (e.g., 100 first place winners will receive an iPod®, and 1000 second place winners will receive a $100 iTunes® gift card), the user 118 may be given a choice of awards (e.g., choose an iPod® or a Zune® as your first place award), and/or the award may not be revealed to the user 118 until after the contest is completed.

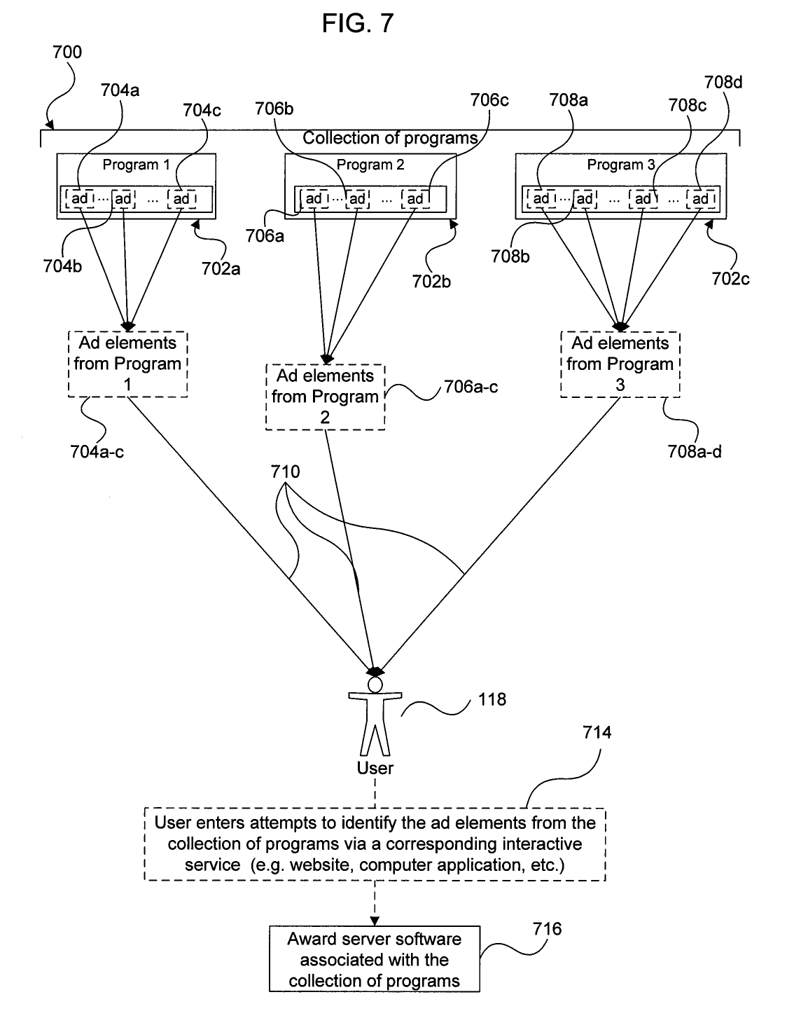

FIG. 7 illustrates an example where a user 118 attempts to identify a plurality of advertising elements from a plurality of different audiovisual programs 702a, 702b, 702c (collectively referred to as audiovisual program 700). Although the collective program 700 in this example includes a series of programs 702a, 702b, 702c, any suitable collection of programs may be logically grouped together. In this example, the advertising elements within each audiovisual program 702a, 702b, 702c are indicated by dashed boxes 704a, 704b, 704c for program 702a, dashed boxes 706a, 706b, 706c for program 702b, and dashed boxes 708a, 708b, 708c for program 702c.

A user 118 views the advertising elements in the collective program 700 denoted by lines 710. This user 118 then visits an interactive service 716 related to the collective program 700. As described above, the user 118 may be presented with a depiction and/or description of the award(s) the user 118 is trying to obtain, the user 118 may be given a choice of awards, and/or the award may not be reveled to the user 118 until after the contest is completed. As indicated by dashed box 714, the user preferably attempts to identify some or all of the advertising elements 704a, 704b, 704c, 706a, 706b, 706c, 708a, 708b, 708c, and 708d by sending information to the interactive service 716.

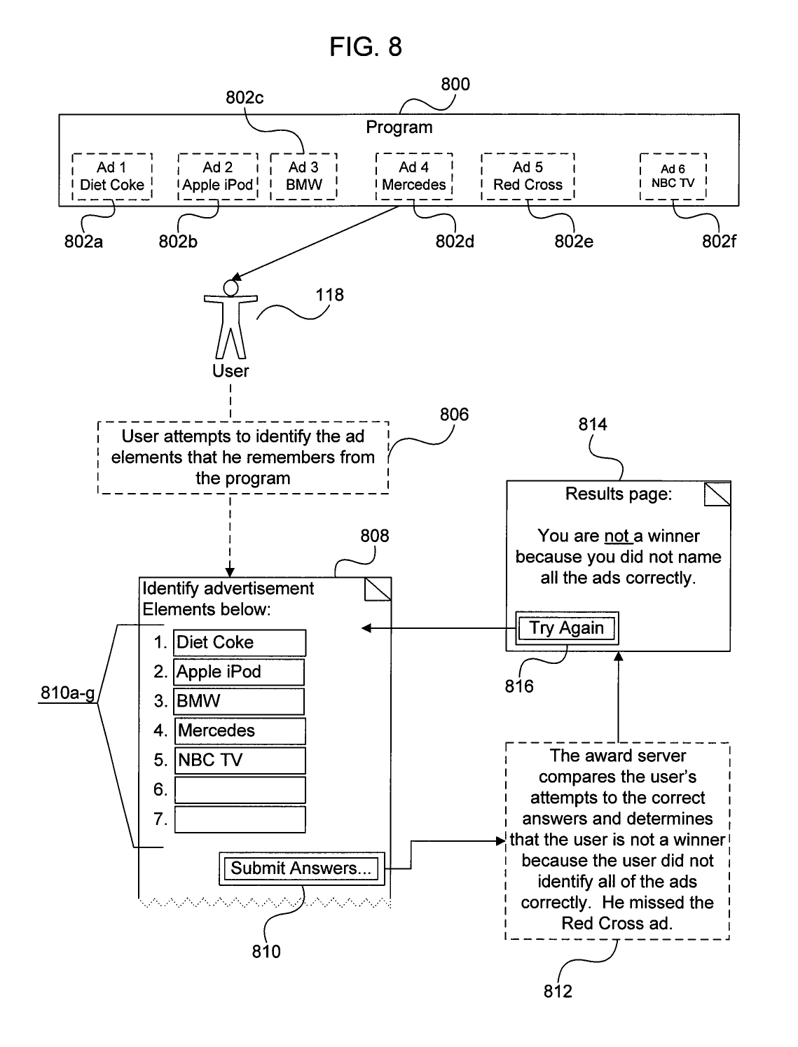

FIG. 8 illustrates an example where a user 118 must accurately identify all of the advertising elements 802a, 802b, 802c, 802d, 802e, 802f associated with a program 800 in a correct chronological order to win an award. The user 118 watches the program 800 and then submits information identifying the advertising elements that he remembers from the program 800, indicated by dashed box 806. The user 118 submits his attempts into an interface 808 similar to that of 504 from FIG. 5. The user 118 submits his attempts into entry boxes 810a, 810b, 810c, 810d, 810e, 810f, 810g. In this example, the user 118 enters advertising element 802a (“Diet Coke”) into entry box 810a; advertising element 802b (“Apple iPod”) into entry box 810b; advertising element 802c (“BMW”) into entry box 810c; and advertising element 802d (“Mercedes”) into entry box 810d. The user then incorrectly enters advertising element 802f (“NBC TV”) into entry box 810e. The user 118 omitted advertising element 802e (“Red Cross”). In this example, there are more entry boxes than there are correct answers so that the user does not know how many advertising elements are associated with a correct attempt. Accordingly, the user 118 leaves entry boxes 810f and 810g blank.

The user 118 then submits his attempts via a submit answers button 810. The user's attempts are then transmitted to logic block 812 of the award server 106. The system compares the user's attempts to the correct answers and determines that the user 118 is not a winner because the user 118 did not correctly identify all the advertising elements correctly. As indicated above, the user 118 did not enter the Red Cross advertising element.

The award server 106 then sends a results page 814 to the user 118. In this example, the results page 814 indicates that the user 118 is not a winner. The user 118 is given the option to try again by pressing a try again button 816, which returns the user 118 to the entry interface 808. In this example, there is no limit to how many times a user 118 can attempt to identify the advertising elements. However, in some instances, there may be a limit on how many times a user 118 can attempt to identify the advertising elements.

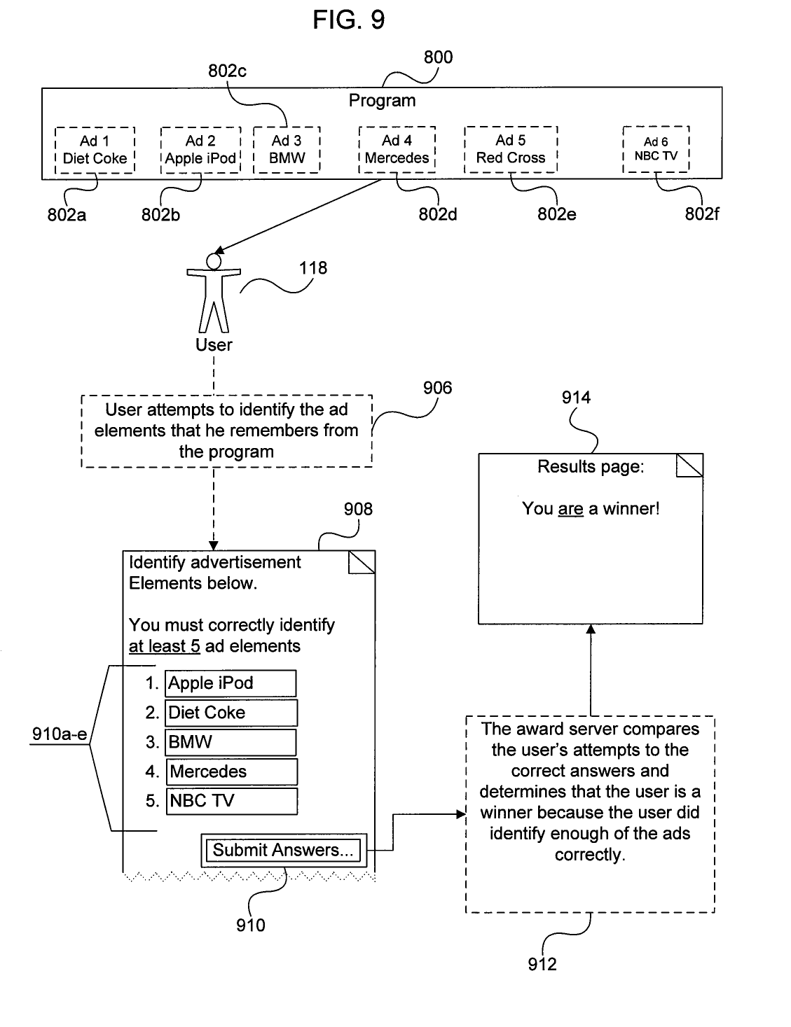

FIG. 9 illustrates an example where a user 118 must accurately identify at least five of the advertising elements 802a, 802b, 802c, 802d, 802e, 802f associated with the program 800 in any chronological order to win an award. Again, the user 118 watches the program 800 and then submits information identifying the advertising elements that he remembers from the program 800, indicated by dashed box 906. The user 118 submits his attempts into the entry boxes 910a, 910b, 910c, 910d, 910e of interface 908. In this example, the user 118 enters advertising element 802b (“Apple iPod”) into entry box 910a; advertising element 802a (“Diet Coke”) into entry box 910b; advertising element 802c (“BMW”) into entry box 910c; advertising element 802d (“Mercedes”) into entry box 910d; and advertising element 802f (“NBC TV”) into entry box 910e.

In this example, there are exactly the right number of entry boxes for the number of correct answers required, so the user knows how many advertising elements to attempt to identify. In other examples, the user 118 may be allowed to make additional attempts (e.g., seven total attempts when only five correct attempts are required) in order to increase a user's chances of winning. In some examples, frequent users of the system may be rewarded with additional attempt boxes.

The user 118 omitted advertising element 802e (“Red Cross”), and the user 118 did not enter the advertising elements in chronological order. More specifically, the user 118 entered the second advertising element 802b (“Apple iPod”) into the first entry box 910a and the first advertising element 802a (“Diet Coke”) into the second entry box 910b. However, for this example, the contest does not specify that the advertising elements must be entered in a correct chronological order, therefore, this user 118 has entered the answers in a correct format.

The user 118 then submits his attempts via a submit answers button 910. The user's attempts are then transmitted to logic block 912 of the award server 106. The system compares the user's attempts to the correct answers and determines that the user 118 is a winner because the user 118 did correctly identify enough of the advertising elements. The award server 106 then sends a results page 914 to the user 118. In this example, the results page 914 indicates that the user 118 is a winner.

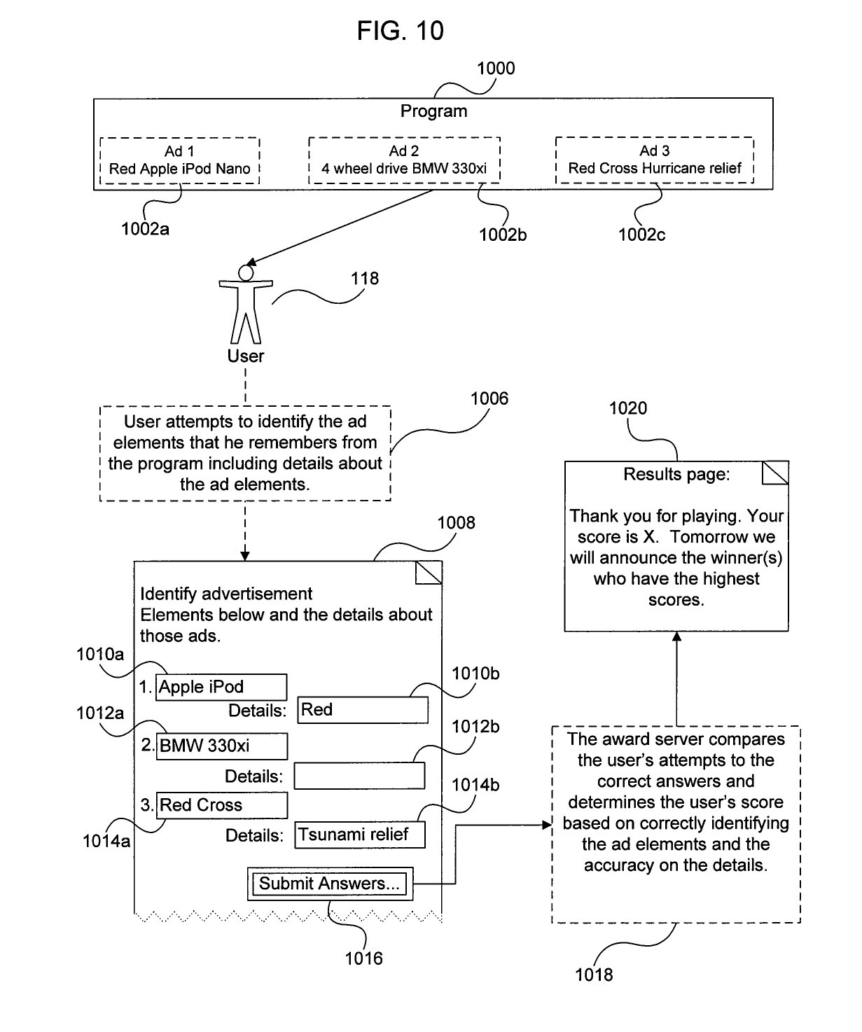

FIG. 10 illustrates an example where a user 118 must accurately identify a plurality of advertising elements 1002a, 1002b, 1002c associated with a program 1000 by entering or selecting details about those advertising elements 1002a, 1002b, 1002c, such as specifics, color, model, etc.

After a user 118 watches the program 1000, the user 118 enters information associated with the details of advertising elements 1002a, 1002b, 1002c he remembers, denoted by action box 1006, into an award server interface 1008. In this example, the user 118 correctly identifies the three advertising elements by entering general information associated with each advertising element 1002a, 1002b, 1002c into entry boxes 1010a, 1012a, and 1014a respectively. In addition, the user 118 enters details associated with the advertising elements 1002a, 1002b, 1002c into the entry boxes 1010b, 1012b, 1014b pertaining to entry boxes 1010a, 1012a, and 1014a respectively.

In this example, the user 118 remembered that the iPod from advertising element 1002a was “Red”. However, the user 118 did not remember that the model was a “Nano”. Additionally the user 118 did not enter any options about the BMW advertising element. Lastly, the user 118 incorrectly identified the specifics about the Red Cross advertising element 1002c as being an advertisement for tsunami relief when in actuality the Red Cross advertising element 1002c was for Hurricane relief.

Once the user has entered his attempts into the entry boxes 1010a, 1012a, 1014a, 1010b, 1012b, 1014b, the user 118 submits his attempts via a submit answers button 1016. The user's attempts are then transmitted to the award server 106 where they are compared to the correct answers as illustrated in logic block 1018.

The user is then sent a results page 1020 where the user 118 sees a numerical representation of his accuracy, denoted by “X” on the results page 1020. In this example, only the users 118 with the highest scores win, and therefore the user 118 is notified that the winners will be announced “tomorrow” after all users 118 have submitted their answers.

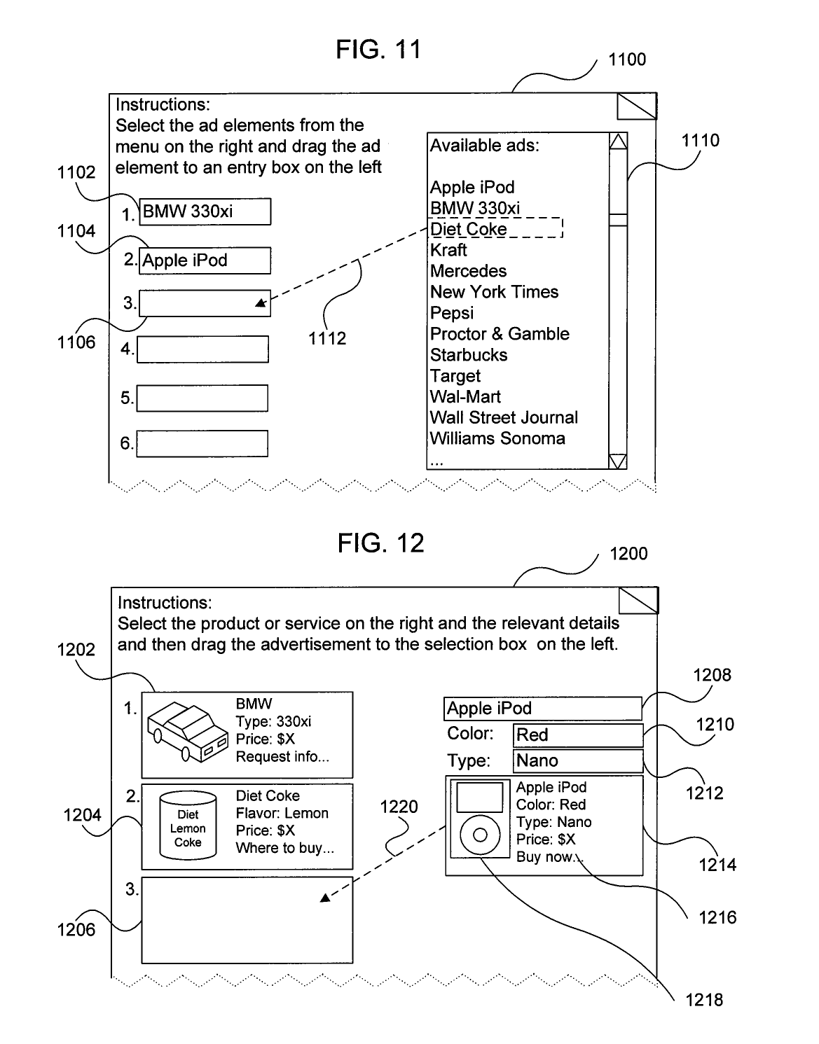

There are many ways a user 118 may enter attempts associated with the advertising elements. For example, as discussed above, a user 118 may enter text into one or more entry boxes via an interface device, such as keyboard. As illustrated in FIG. 11 another way a user 118 may enter attempts associated with the advertising elements is to select the plurality of attempts from a selection menu or list. In this example, the selection interface 1110 has a list of available advertising elements 1110. The user can select from the list and drag the various advertising elements to the entry boxes 1102, 1104, 1106. In this example, the user 118 selected “BMW 330xi” and “Apple iPod” from the list of available advertising elements 1110 and entered them in entry box 1102 and 1104 respectively. For the third entry box 1106, the dashed line 1112 indicates the user 118 dragging the advertising element “Diet Coke” from the list 1110 to the entry box 1106.

FIG. 12 illustrates another possible entry method wherein the interface 1200 requests additional details about the advertising elements. In this example, the user 118 enters the advertising element (“Apple iPod”) into box 1208. The interface 1200 then asks the user 118 for additional information. In this example, the interface 1200 asks the user 118 for details about the color and the type of iPod. The user 118 is then required to enter those details into entry boxes 1210 and 1212 respectively. Corresponding to this advertising element a visual 1218 is displayed in box 1214 so that the user 118 can see the product he is selecting including additional details, such as price 1216 and a hyperlink to purchase or find out more about the product. This is advantageous for the advertisers because it allows users to purchase that product or service or learn more directly from the interface 1200.

Once the user 118 has identified the advertising element and required details, the user 118 can drag the information to one of the available entry boxes. In this example the dashed line 1220 indicates that the user is moving the information 1214 to the entry box 1206. This example further displays the user has entered an ad for a BMW, type 330xi with price $X into the entry box 1202 and an ad for Diet Coke, Lemon flavor, and price $X into entry box 1204.

In summary, persons of ordinary skill in the art will readily appreciate that methods and apparatus for awarding consumers of advertising content have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

1. A method of audiovisual advertising, the method comprising:
facilitating distribution of an audiovisual program, the audiovisual program including entertainment content and a plurality of advertising elements;
facilitating distribution of a software program associated with the audiovisual program, the software program (a) enabling a user to identify the plurality of advertising elements by identifying a plurality of aspects associated with the plurality of advertising elements, and (b) being structured to access a data structure storing first data indicative of the plurality of aspects in logical association with second data indicative of the audiovisual program to determine if the user correctly identifies the plurality of advertising elements; and
facilitating distribution of an award to the user for correctly identifying the plurality of advertising elements.

2. The method of claim 1, wherein distribution of the audiovisual program includes distribution via at least one of terrestrial television broadcasting, cable television broadcasting, and satellite television broadcasting.

3. The method of claim 1, wherein distribution of the audiovisual program includes distribution via a computer network.

4. The method of claim 3, wherein distribution of the audiovisual program via the computer network includes distribution via an Internet.

5. The method of claim 4, wherein distribution of the audiovisual program via the Internet includes wireless communication.

6. The method of claim 1, wherein distribution of the audiovisual program includes distribution to a television.

7. The method of claim 1, wherein distribution of the audiovisual program includes distribution to a personal computer.

8. The method of claim 1, wherein distribution of the audiovisual program includes distribution to a portable electronic device.

9. The method of claim 8, wherein the portable electronic device includes at least one of personal digital assistant, a portable video player, and a mobile telephone.

10. The method of claim 1, wherein the audiovisual program includes at least one of a television show, an Internet show, and a movie.

11. The method of claim 1, wherein the audiovisual program includes a first show and a second different show.

12. The method of claim 1, wherein the audiovisual program includes interactive content.

13. The method of claim 12, wherein the interactive content includes a video game.

14. The method of claim 1, wherein the entertainment content includes the plurality of advertising elements.

15. The method of claim 1, wherein the plurality of advertising elements includes a spot advertisement.

16. The method of claim 1, wherein the plurality of advertising elements includes a placement advertisement.

17. The method of claim 16, wherein the plurality of advertising elements includes a spot advertisement.

18. The method of claim 1, wherein the plurality of advertising elements includes a first advertising element associated with a first advertiser and a second advertising element associated with a second different advertiser.

19. The method of claim 1, wherein the plurality of aspects includes at least one of a product name, a product type, a service name, a service type, a brand name, and an entity name.

20. The method of claim 1, wherein the plurality of aspects includes at least two of a product name, a product type, a service name, a service type, a brand name, and an entity name.

21. The method of claim 1, wherein the plurality of aspects includes at least one of a product color, a product model, a product version, a product feature, and a product action.

22. The method of claim 1, wherein the plurality of aspects includes at least two of a product color, a product model, a product version, a product feature, and a product action.

23. The method of claim 1, wherein the software program enables the user to identify the plurality of aspects via an Internet application.

24. The method of claim 1, wherein the software program enables the user to identify the plurality of aspects via a portable electronic device.

25. The method of claim 24, wherein the portable electronic device includes at least one of a personal digital assistant, a portable video player, a portable audio player, and a mobile telephone.

26. The method of claim 24, wherein the portable electronic device includes a television remote control device.

27. The method of claim 1, wherein the software program enables the user to identify the plurality of aspects via at least one of a television, a satellite television receiver, a cable television receiver, and an audiovisual playback device.

28. The method of claim 1, wherein the software program enables the user to identify the plurality of aspects by entering alphanumeric data.

29. The method of claim 1, wherein the software program enables the user to identify the plurality of aspects by selecting items from a list of items.

30. The method of claim 29, wherein the software program enables the user to identify the plurality of aspects by entering an alphanumeric description.

31. The method of claim 1, wherein the software program enables the user to identify the plurality of aspects using a search feature.

32. The method of claim 1, wherein the software program allows frequent users to make more attempts than infrequent users.

33. The method of claim 1, wherein the software program provides a hyperlink to information associated with an advertised product

34. The method of claim 1, wherein to determine if the user correctly identifies the plurality of advertising elements, the software program is structured to require that at least a subset of the advertising elements be identified with a chronological order, the chronological order being an order of presentation within the audiovisual program.

35. The method of claim 1, wherein to determine if the user correctly identifies the plurality of advertising elements, the software program is structured to not require any subset of the advertising elements be identified with a chronological order, the chronological order being an order of presentation within the audiovisual program.

36. The method of claim 1, wherein to determine if the user correctly identifies the plurality of advertising elements, the software program is structured to require that each advertising element in the plurality of advertising elements be identified.

37. The method of claim 36, wherein to determine if the user correctly identifies the plurality of advertising elements, the software program is structured to require that at least a subset of the advertising elements be identified with a chronological order, the chronological order being an order of presentation within the audiovisual program.

38. The method of claim 36, wherein to determine if the user correctly identifies the plurality of advertising elements, the software program is structured to not require any subset of the advertising elements be identified with a chronological order, the chronological order being an order of presentation within the audiovisual program.

39. The method of claim 1, wherein to determine if the user correctly identifies the plurality of advertising elements, the software program is structured to require that at least a predetermined number of advertising elements in the plurality of advertising elements be identified, wherein the predetermined number of advertising elements is less than all of the advertising elements.

40. The method of claim 39, wherein to determine if the user correctly identifies the plurality of advertising elements, the software program is structured to require that at least a subset of the advertising elements be identified with a chronological order, the chronological order being an order of presentation within the audiovisual program.

41. The method of claim 39, wherein to determine if the user correctly identifies the plurality of advertising elements, the software program is structured to not require any subset of the advertising elements be identified with a chronological order, the chronological order being an order of presentation within the audiovisual program.

42. The method of claim 1, wherein the data structure represents one number of points for identifying a specific aspect and another lower number of points for identifying a general aspect.

43. The method of claim 1, wherein facilitating distribution of the award to the user includes sending the user a monetary award.

44. The method of claim 43, wherein the monetary award includes at least one of a credit and a gift certificate.

45. The method of claim 1, wherein facilitating distribution of the award to the user includes sending the user a product.

46. The method of claim 1, wherein facilitating distribution of the award to the user includes providing the user with a service.

47. The method of claim 1, wherein facilitating distribution of the award to the user includes sending the user the award via a computer network.

48. The method of claim 1, wherein facilitating distribution of the award to the user includes sending the user the award via a physical delivery system.

49. The method of claim 1, wherein a level associated with the award is based on an accuracy score associated with the user, the accuracy score being associated with identification of the plurality of advertising elements.

50. The method of claim 49, wherein the accuracy score associated with the user is a running accuracy score associated with a plurality of audiovisual programs.

51. The method of claim 49, wherein the accuracy score associated with the user is a relative accuracy score with respect to a plurality of accuracy scores associated with a plurality of different users.

52. The method of claim 1, wherein a level associated with the award is based on a timeliness score associated with the user, the timeliness score being associated with identification of the plurality of advertising elements.

53. The method of claim 52, wherein the timeliness score associated with the user is a running timeliness score associated with a plurality of audiovisual programs.

54. The method of claim 52, wherein the timeliness score associated with the user is a relative timeliness score with respect to a plurality of timeliness scores associated with a plurality of different users.

55. The method of claim 1, including limiting a number of winners associated with the audiovisual program to a predetermined number of winners based on an accuracy score associated with each winner in the predetermined number of winners.

56. The method of claim 55, wherein the predetermined number of winners is equal to one.

57. The method of claim 55, wherein a plurality of award levels associated with a plurality of awards distributed to the predetermined number of winners varies based on a plurality of accuracy scores.

58. The method of claim 55, wherein a plurality of award levels associated with a plurality of awards distributed to the predetermined number of winners varies based on a plurality of relative accuracy scores.

59. The method of claim 1, including limiting a number of winners associated with the audiovisual program to a predetermined number of winners based on a timeliness score associated with each winner in the predetermined number of winners.

60. The method of claim 59, wherein the predetermined number of winners is equal to one.

61. The method of claim 59, wherein a plurality of award levels associated with a plurality of awards distributed to the predetermined number of winners varies based on a plurality of timeliness scores.

62. The method of claim 59, wherein a plurality of award levels associated with a plurality of awards distributed to the predetermined number of winners varies based on a plurality of relative timeliness scores.

63. The method of claim 1, including limiting a number of winners associated with the audiovisual program to a predetermined number of winners based on a combination of (i) an accuracy score associated with each winner in the predetermined number of winners, and (ii) a timeliness score associated with each winner in the predetermined number of winners.

64. The method of claim 63, wherein a plurality of award levels associated with a plurality of awards distributed to the predetermined number of winners varies based on a plurality of accuracy scores and a plurality of timeliness scores.

65. The method of claim 63, wherein a plurality of award levels associated with a plurality of awards distributed to the predetermined number of winners varies based on a plurality of relative accuracy scores and a plurality of relative timeliness scores.

66. The method of claim 63, wherein the predetermined number of winners is equal to one.

67. The method of claim 1, wherein the software program (c) is structured to require the user to attempt to identify the plurality of advertising elements within a predetermined time period.

68. The method of claim 67, wherein the predetermined time period is defined by a specific time on a specific date of a specific year.

69. The method of claim 67, wherein the predetermined time period is defined by a predetermined offset from a display time associated with the audiovisual program.

70. An apparatus for awarding viewers of audiovisual advertising associated with an audiovisual program, the apparatus comprising:
a processor;
a memory device operatively coupled to the processor;
an input device operatively coupled to the processor; and
an output device operatively coupled to the processor, wherein the processor:
causes the output device to send first data indicative of a display, the display enabling a user to identify a plurality of advertising elements by identifying a plurality of aspects associated with the plurality of advertising elements;
causes the input device to receive second data from the user, the second data being indicative of an attempt to identify the plurality of aspects;
accesses a data structure in the memory device, the data structure storing first data indicative of the plurality of aspects in logical association with second data indicative of the audiovisual program to determine if the attempt correctly identifies the plurality of advertising elements; and
causes the output device to send third data indicative one of (a) a success associated with the attempt and (b) a failure associated with the attempt.

71. The apparatus of claim 70, wherein the display includes a first display portion indicative of at least one of the plurality of aspects in graphical association with a second display portion indicative of the audiovisual program.

72. The apparatus of claim 70, wherein the plurality of advertising elements includes a placement advertisement.

73. The apparatus of claim 70, wherein the plurality of advertising elements includes a first advertising element associated with a first advertiser and a second advertising element associated with a second different advertiser.

74. The apparatus of claim 70, wherein the plurality of aspects includes at least one of a product name, a product type, a service name, a service type, a brand name, an entity name, a product color, a product model, a product version, a product feature, and a product action.

75. The apparatus of claim 70, wherein to determine if the attempt correctly identifies the plurality of advertising elements, the processor requires that at least a subset of the advertising elements be identified with a chronological order, the chronological order being an order of presentation within the audiovisual program.

76. The apparatus of claim 70, wherein to determine if the attempt correctly identifies the plurality of advertising elements, the processor requires that at least a predetermined number of advertising elements in the plurality of advertising elements be identified, wherein the predetermined number of advertising elements is less than all of the advertising elements.

77. The apparatus of claim 70, wherein if the third data is indicative of a success, the third data includes an award level.

78. The apparatus of claim 77, wherein the award level is based on an accuracy score associated with the user, the accuracy score being associated with identification of the plurality of advertising elements.

79. The apparatus of claim 77, wherein the award level is based on an timeliness score associated with the user, the timeliness score being associated with identification of the plurality of advertising elements.

80. A computer readable medium storing software instructions structured to cause at least one computing device to:
enable a user to identify a plurality of advertising elements by identifying a plurality of aspects associated with the plurality of advertising elements;
access a data structure storing first data indicative of the plurality of aspects in logical association with second data indicative of entertainment content associated with the plurality of advertising elements to determine if the user correctly identifies the plurality of advertising elements; and
generate data indicative of one of (a) a success associated with an attempt by the user to correctly identify the plurality of advertising elements and (b) a failure associated with the attempt by the user to correctly identify the plurality of advertising elements.

81. The computer readable medium of claim 80, wherein the software instructions are structured to cause the at least one computing device to generate data indicative of a first display portion, the first display portion being indicative of at least one of the plurality of aspects in graphical association with a second display portion indicative of the entertainment content.

82. The apparatus of claim 80, wherein the plurality of advertising elements includes a placement advertisement.

83. The apparatus of claim 80, wherein the plurality of advertising elements includes a first advertising element associated with a first advertiser and a second advertising element associated with a second different advertiser.

84. The apparatus of claim 80, wherein the plurality of aspects includes at least one of a product name, a product type, a service name, a service type, a brand name, an entity name, a product color, a product model, a product version, a product feature, and a product action.

85. The apparatus of claim 80, wherein to determine if the user correctly identifies the plurality of advertising elements, the software instructions are structured to cause the at least one computing device to require that at least a subset of the advertising elements be identified with a chronological order, the chronological order being an order of presentation within the entertainment content

86. The apparatus of claim 80, wherein to determine if the user correctly identifies the plurality of advertising elements, the software instructions are structured to cause the at least one computing device to require that at least a predetermined number of advertising elements in the plurality of advertising elements be identified, wherein the predetermined number of advertising elements is less than all of the advertising elements.

87. The apparatus of claim 80, wherein if the data is indicative of a success, the data includes an award level.

88. The apparatus of claim 87, wherein the award level is based on an accuracy score associated with the user, the accuracy score being associated with identification of the plurality of advertising elements.

89. The apparatus of claim 87, wherein the award level is based on an timeliness score associated with the user, the timeliness score being associated with identification of the plurality of advertising elements.

90. A method of audiovisual advertising, the method comprising:
facilitating distribution of an audiovisual program, the audiovisual program including entertainment content and a plurality of advertising elements;
facilitating distribution of a software program associated with the audiovisual program, the software program (a) enabling a user to identify the plurality of advertising elements by identifying a plurality of aspects associated with the plurality of advertising elements, and (b) being structured to generate a first display portion indicative of the plurality of aspects in graphical association with a second display portion indicative of the audiovisual program; and
facilitating distribution of an award to the user for correctly identifying the plurality of products advertised in the advertising content.

91. The method of claim 90, wherein the first display portion and the second display portion are displayed on a single display page.

92. The method of claim 90, wherein the first display portion is displayed on a first display page and the second display portion is displayed on a second different display page.
